(19) United States
(12) Patent Application Publication
(10) Pub. No.: US 2025/0246889 A1
(43) Pub. Date: Jul. 31, 2025

(54) LOW VOLTAGE PLATE

(71) Applicant: Hubbell Incorporated, Shelton, CT (US)

(72) Inventors: Krzysztof Wojciech Korcz, Granger, IN (US); Victor Beristany, South Bend, IN (US); Krishna C. Patel, Granger, IN (US)

(21) Appl. No.: 19/039,089

(22) Filed: Jan. 28, 2025

Related U.S. Application Data
(60) Provisional application No. 63/637,090, filed on Apr. 22, 2024.
(60) Provisional application No. 63/626,137, filed on Jan. 29, 2024.

(51) Int. Cl. H02G 3/14

(52) U.S. Cl. CPC H02G 3/14

(57) ABSTRACT

A mounting plate for supporting a low voltage device includes a body, an opening, a first mounting section, and a second mounting section. The body includes a first side wall having a recessed region, and a second side wall opposite to the first side wall. The second side wall includes a projection aligned with the recessed region. The first side wall and the second side wall extend between a first end and a second end of the body. The opening is formed between the first side wall and the second side wall. The first mounting section is coupled between the first side wall and the second side wall on the first end of the body. The second mounting section is coupled between the first side wall and the second side wall on the second end of the body.

### CROSS-REFERENCE TO RELATED APPLICATIONS

This application claims the benefit of U.S. Provisional Patent Application No. 63/637,090, filed Apr. 22, 2024 and U.S. Provisional Patent Application No. 63/626,137, filed Jan. 29, 2024, the entire contents of these are incorporated herein by reference in their entirety.

### FIELD

The present disclosure relates to a mounting plate. More particularly, the present disclosure relates to multiple mounting plates selectively connected together to form gang sizes.

### BACKGROUND

Low voltage electrical devices may be installed (e.g., in a ceiling or wall) without requiring an electrical box to support the device. Instead, a mud ring or low voltage plate may be used by themselves to support the low voltage device (e.g., across a brace). The mud ring or low voltage plate generally lacks a bracket or other mounting feature, and an additional bracket is required to mount the device. This may be expensive as multiple elements are required to mount the device.

Additionally, typical mud rings are manufactured for single gang or two gang applications. These mud rings are not capable for being modified of use when other gangs are required. This requires additional parts and manufacturing costs to meet the different use cases.

### SUMMARY

Various embodiments of the present disclosure can overcome various of the aforementioned and other disadvantages associated with known mounting plates and offer new advantages as well.

According to one aspect of various embodiments of the present disclosure there is provided an integrally formed ring and mounting feature, the ring can receive an electrical device.

According to another aspect of various embodiments of the present disclosure, there is provided a body with one or more gang opening and a mounting bracket integrally connected to the body.

According to another aspect of various embodiments of the present disclosure, there is provided a mounting plate for supporting a low voltage device that includes a body with an opening for receiving a low voltage electrical device and a mounting section for connecting with a rail.

According to another aspect of various embodiments of the present disclosure, there is provided a mounting plate for supporting a low voltage device that includes a body with an opening for receiving a low voltage electrical device and a mounting section for connecting with a support.

According to another aspect of various embodiments of the present disclosure, there is provided a mounting plate for supporting a low voltage device that includes a body with an opening for receiving a low voltage electrical device. The body includes a finger that can secure an electrical conductor for connection with the low voltage electrical device.

According to another aspect of various embodiments of the present disclosure, there is provided a mounting plate for supporting a low voltage device that includes a body, an opening, a first mounting section, and a second mounting section. The body includes a first side wall having a recessed region, and a second side wall opposite to the first side wall. The second side wall includes a projection aligned with the recessed region. The first side wall and the second side wall extend between a first end and a second end of the body. The opening is formed between the first side wall and the second side wall. The first mounting section is coupled between the first side wall and the second side wall on the first end of the body. The second mounting section is coupled between the first side wall and the second side wall on the second end of the body.

According to another aspect of various embodiments of the present disclosure, there is provided a mounting plate for supporting a low voltage device that includes a body, an opening, a first mounting section, and a second mounting section. The body includes a first side wall and a second side wall opposite to the first side wall. The first side wall and the second side wall extend along a first axis between a first end and a second end of the body. The opening is formed between the first side wall and the second side wall. The first mounting section is coupled between the first side wall and the second side wall on the first end of the body. The first mounting section includes a first section and a first projection that extends from the first section along a second axis that is perpendicular to the first axis. The second mounting section is coupled between the first side wall and the second side wall on the second end of the body. The second mounting section includes a second section and a second projection that extends from the second section along a third axis that is parallel to the second axis.

According to another aspect of various embodiments of the present disclosure, there is provided a method of manufacturing a mounting plate including bending a flat piece of material into a three-dimensional shape.

According to another aspect of various embodiments of the present disclosure, there is provided a method of manufacturing a mounting plate including: forming a blank from a piece of material; bending the blank into a mounting panel having a three-dimensional shape, the mounting panel including, a first side wall with a first end and a second end, a first mounting section coupled to the first end, a second mounting section coupled to the second end, a first panel connected to the first mounting section and positioned opposite of the first side wall, and a second panel connected to the second mounting section and positioned opposite of the first side wall; and coupling the first panel to the second panel to form a second side wall opposite the first side wall; wherein an opening is at least partially formed between the first side wall and the second side wall.

According to another aspect of various embodiments of the present disclosure, there is provided a method of mounting a low voltage device, the method including: connecting a first plate between a pair of rails, the first plate having an integral mounting bracket for connecting to the rails; and connecting a second plate between the pair of rails in contact with the first plate, the first plate having an integral mounting bracket for connecting to the rails.

According to another aspect of various embodiments of the present disclosure, there is provided a method of mounting a low voltage device, the method including: selecting a first mounting plate having a first opening with a first gang size and a second mounting plate having a second opening with a second gang size; connecting the first mounting plate and the second mounting plate between a pair of rails; securing the first mounting plate to the rails; securing the second mounting plate to the rails in contact with the first mounting plate; and combining the first opening and the second opening to form a third gang size that is equal to the first gang size plus the second gang size.

According to another aspect of various embodiments of the present disclosure, there is provided a method of mounting a low voltage device, the method including: selecting a first mounting plate having a first opening with a first gang size and a second mounting plate having a second opening with a second gang size; connecting the first mounting plate directly to a support; connecting the second mounting plate directly to the first mounting plate; and combining the first opening and the second opening to form a third gang size that is equal to the first gang size plus the second gang size.

According to another aspect of various embodiments of the present disclosure, there is provided a method of mounting a low voltage device, the method including: positioning a first electrical device within a first opening of a first mounting plate; connecting a protective cover to the first mounting plate to cover the first opening; installing a surface material over the first mounting plate and the support; cutting the surface material to expose the protective cover; and removing the protective cover.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is a perspective view of a first example of a low voltage plate.

FIG. 2 is a top view of the low voltage plate of FIG. 1.

FIG. 3 is a first side view of the low voltage plate of FIG. 1.

FIG. 4 is a second side view of the low voltage plate of FIG. 1.

FIG. 5 is a cross-sectional view of the low voltage plate of FIG. 1 viewed along section 5-5.

FIG. 6 is a detail view of the low voltage plate of FIG. 1 illustrating a first connection.

FIG. 7 is a cross-sectional view of the low voltage plate of FIG. 6 viewed along section 7-7.

FIG. 8 is a perspective view of a second example of a low voltage plate.

FIG. 9 is a perspective view of a third example of a low voltage plate.

FIG. 10 is a top view of the low voltage plate of FIG. 9.

FIG. 11 is a first side view of the low voltage plate of FIG. 9.

FIG. 12 is a cross-sectional view of the low voltage plate of FIG. 9 viewed along section 12-12.

FIG. 13 is a cross-sectional view of the low voltage plate of FIG. 9 viewed along section 13-13.

FIG. 14 is a perspective view of a fourth example of a low voltage plate.

FIG. 15 is a top view of the low voltage plate of FIG. 14.

FIG. 16 is a first side view of the low voltage plate of FIG. 14.

FIG. 17 is a cross-sectional view of FIG. 14 viewed along section 17-17.

FIG. 18 is a cross-sectional view of FIG. 14 viewed along section 18-18.

FIG. 19 is a perspective view of the low voltage plate of FIG. 1 connected to a brace in a first position.

FIG. 20 is a top view of FIG. 19 illustrating the low voltage plate connected to the brace.

FIG. 21 is a cross-sectional view of FIG. 20 viewed along section 21-21.

FIG. 22 is a perspective view of the low voltage plate of FIG. 1 connected to a brace in a second position.

FIG. 23 is a top view of FIG. 22 illustrating the low voltage plate connected to the brace.

FIG. 24 is a cross-sectional view of FIG. 23 viewed along section 24-24.

FIG. 25 is a first perspective view of a fifth example of a low voltage plate.

FIG. 26 is a second perspective view of the low voltage plate of FIG. 25.

FIG. 27 is a top view of the low voltage plate of FIG. 25.

FIG. 28 is a first side view of the low voltage plate of FIG. 25.

FIG. 29 is a second side view of the low voltage plate of FIG. 25.

FIG. 30 is a cross-sectional view of the low voltage plate of FIG. 25 viewed along section 30-30.

FIG. 31 is a perspective view of a blank used to form the low voltage plate of FIG. 25.

FIG. 32 is a front view of the blank of FIG. 31.

FIG. 33 is a front perspective view of a cover for the low voltage plate of FIG. 25.

FIG. 34 is a rear perspective view of the cover of FIG. 33.

FIG. 35 is a front view of the cover of FIG. 33.

FIG. 36 is a side view of the cover of FIG. 33.

FIG. 37 is a perspective view of a pair of low voltage plates of FIG. 25 connected to a brace.

FIG. 38 is a top view of FIG. 37 illustrating the pair of low voltage plates connected to the brace.

FIG. 39 is a cross-sectional view of FIG. 37 viewed along section 39-39.

FIG. 40 is a perspective view of a pair of low voltage plates of FIG. 25 connected to a stud.

FIG. 41 is a top view of FIG. 40 illustrating the pair of low voltage plates connected to a stud.

FIG. 42 is a cross-sectional view of FIG. 40 viewed along section 42-42.

FIG. 43 is a perspective view of the low voltage plates of FIG. 25 connected to a stud.

FIG. 44 is a top view of FIG. 43 illustrating the low voltage plates connected to a stud.

FIG. 45 is a side view of FIG. 43 illustrating the low voltage plates connected to a stud.

FIG. 46 is a cross-sectional view of FIG. 43 viewed along section 46-46.

### DETAILED DESCRIPTION

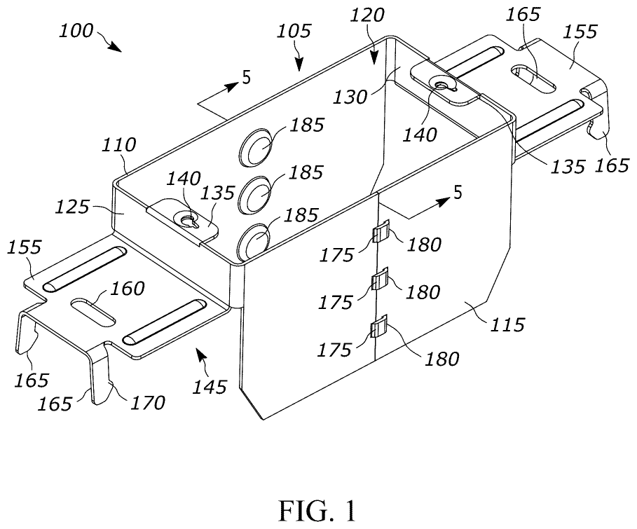

FIG. 1 illustrates a mounting plate 100 that may be used for mounting a device (e.g., a low voltage electrical device). The mounting plate 100 may be a single gang mounting plate 100, although as described below, other examples of the mounting plate may have any number of gangs. The mounting plate 100 may also be constructed from a rigid material (e.g., metal, plastic, etc.).

The mounting plate 100 includes a main body 105 with a first side wall 110 and a second side wall 115 opposite to the first side wall 110. The main body 105 may also include an opening 120 with a volume at least partially formed between the first and second side walls 110, 115. The illustrated opening 120 includes a substantially rectangular shape, although other examples may include another shape (e.g., circular, elliptical, triangular, etc.). The opening 120 may be sized to be a single-gang opening.

In the illustrated example, the volume of the main body 105 may not be fully enclosed. The main body 105 may include a third side wall 125 and a fourth side wall 130 each of which extend between the first and second side walls 110, 115. However, the third and fourth side walls 125, 130 may be shorter than the first and second side walls 110, 115. However, other examples of the mounting plate 100 may include a main body 105 with at least one additional side wall (e.g., extending between the first and second side walls 110, 115) and/or a bottom wall.

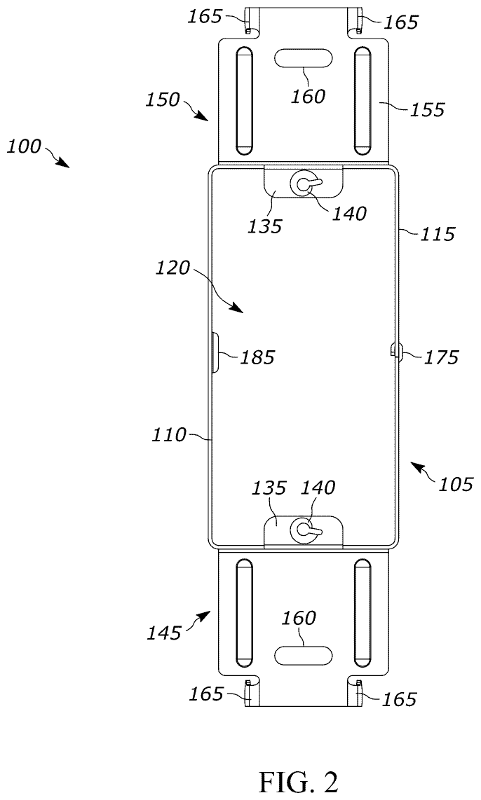

As shown in FIGS. 1 and 2, tabs 135 with mounting openings 140 may be connected to the main body 105. One tab 135 may be connected to the third side wall 125 and one tab 135 may be connected to the fourth side wall. In other examples, both tabs 135 may be connected to the same wall or there may be multiple tabs 135 connected to one or more side walls. In still other examples, one or more tabs 135 may be connected to the first side wall 110 and/or the second side wall 115 in addition to or instead of connection to the third and/or fourth side walls 125, 130.

In the illustrated example, the tabs 135 may be aligned with one another across the opening 120. For example, each tab 135 may extend from its respective side wall 125, 130 toward a center of the opening 120. In this orientation, the mounting opening 140 of each tab 135 may be positioned over the opening 120.

In some forms, each mounting opening 140 may be sized to receive a fastener. For example, the mounting openings 140 may include threads to that correspond to threads of the fastener. The illustrated example may include an inclined section with an inner perimeter adjacent the respective mounting opening 140.

In some forms, the mounting openings 140 may be substantially smooth. For example, the opening may not include any threads.

As shown in FIGS. 1 to 4, a first mounting section 145 may extend from the third side wall 125 and a second mounting section 150 may extend from the fourth side wall 130. For example, each mounting section 145, 150 may extend from a lower edge of the respective side wall 125, 130 (e.g., an edge opposite to the edge that the tab 135 is connected to). Because the third and fourth side walls 125, 130 are smaller than the first and second side walls 110, 115, the first and second mounting sections 145, 150 may not extend below the lower edges of the first and second side walls 110, 115 (e.g., edge opposite the tabs 135). The mounting sections 145, 150 may extend away from one another (e.g., away from the main body 105 and in the opposite directions as the respective tabs 135).

The mounting sections 145, 150 may each have a body 155 with an aperture 160. The illustrated aperture 160 has an elongated shape (e.g., a rounded rectangle, an elliptical, etc.), although other examples of the aperture 160 may have any other shape (e.g., circular, triangular, rectangular, etc.).

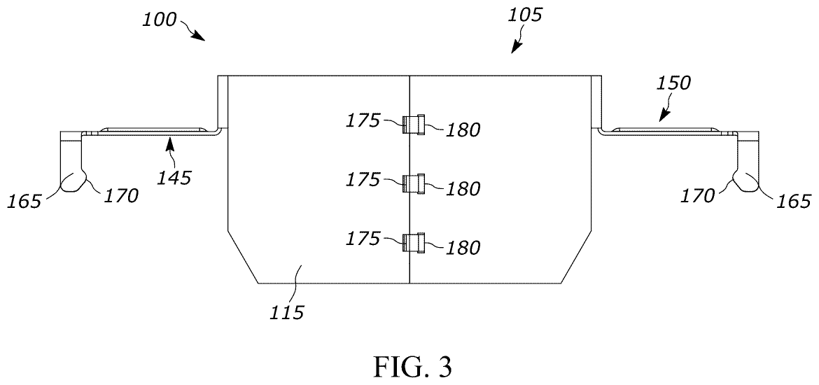

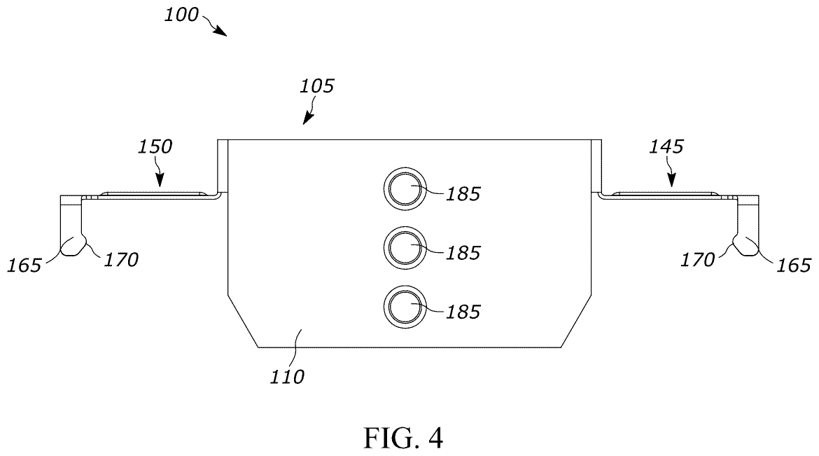

The mounting sections 145, 150 may also include a pair of connecting tabs 165, which may be formed proximate to a free end of the respective mounting section 145, 150. Each connecting tab 165 may be oriented in substantially the same direction (e.g., downwardly). Each tab 165 may also include a finger 170 that may be oriented toward the main body 105. Each finger 170 may be disposed proximate to a free end (e.g., lower end as shown in FIGS. 3 and 4) of the respective tab 165.

In some forms, the mounting plate 100 may be manufactured from a single piece of material (e.g., stamped). In other words, the mounting plate 100 as a whole may be integrally formed from a one-piece construction. For example, the mounting plate 100 may be initially manufactured from a substantially flat piece of material and may be manipulated into the shape illustrated in FIG. 1.

In certain forms, the material may be bent to form the shape of the main body 105 and the mounting sections 145, 150. Additionally, the tabs 165 may be bent away from the respective mounting sections 145, 150 to form the illustrated orientation. In this configuration, the second side wall 115 may being initially separated and may thus need to be connected to form a single wall.

In certain forms, the stamped material may be thin, which may reduce material costs. For example, the stamped material may be between about 0.001 inches thick and about 1 inch thick. The stamped material may be between about 0.01 inches thick and about 0.5 inches thick. The stamped material may be between about 0.015 inches thick and about 0.1 inches thick. The stamped material may be between about 0.02 inches thick and about 0.05 inches thick. The stamped material may be between about 0.03 inches thick and about 0.04 inches thick. The stamped material may be about 0.035 inches thick. Once bent, the walls of the mounting plate 100 have the thickness of the stamped material.

In one form, the stamped material may permit a thinner structure for supporting an electrical device.

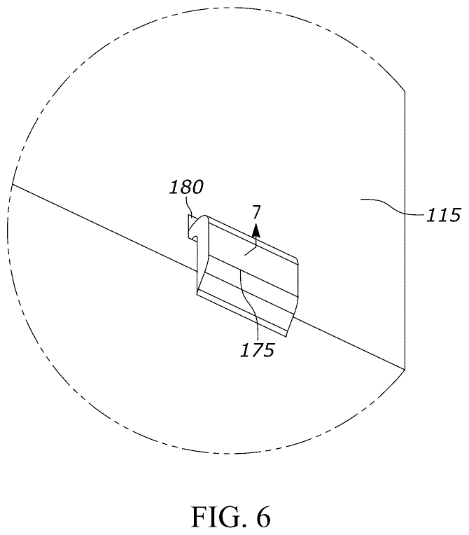

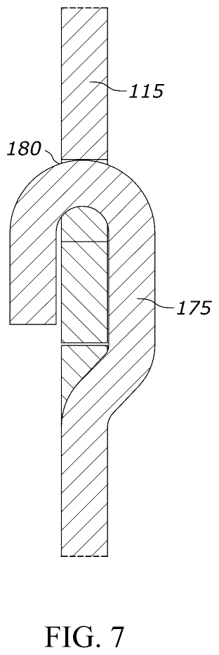

As shown in FIGS. 6 and 7, one way to connect the two panels forming the second side wall 115 may be by using one or more hooks 175 and slots 180. For example, one panel may include at least one hook 175 (e.g., three shown in FIG. 1) and the other panel may include the same number of slots 180. To assemble the two panels into the second side wall 115, the two panels may be brought together and each hook 175 may be bent so that it passes through the respective slot 180. As shown in FIG. 7, each hook 175 may wrap through the respective opening 180 so that a free end of each hook 175 is disposed within the volume of the main body 105. In this position, the free end of each hook 175 may contact an inner surface of the other panel to limit relative movement between the panels. This may maintain the shape of the main body 105.

In other examples, other processes may be used to connect to the panels together to form the main body 105. This may include utilizing a tog lock and/or welding, both of which are described in more detail below.

In still other examples, the mounting plate 100 may be formed from a different material and/or manufacturing process. For example, the mounting plate 100 could be injection molded and formed from a plastic material instead of metal. In these forms, the molded mounting plate 100 may have substantially the same thickness as the stamped mounting plate 100.

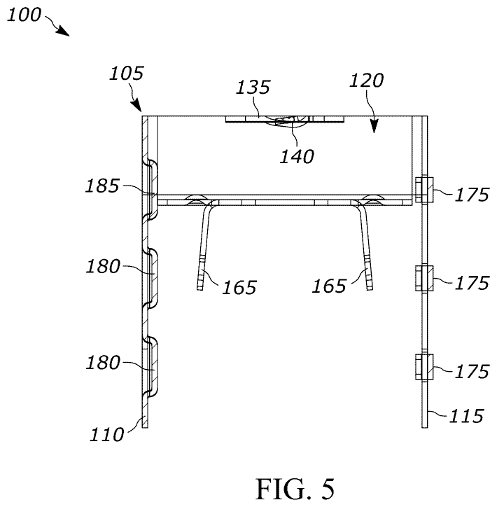

As shown in FIGS. 4 and 5, the first side wall 110 may include one or more cavities 185 (e.g., three shown). The cavities 185 may be depressions formed in the first side wall 110 and may not extend through the first side wall 110 to provide communication with the volume within the main body 105.

In some forms, the main body 105 may include the same number of cavities 185 as hooks 175. Additionally, each cavity 185 may be aligned across the main body 105 with a hook 175 (e.g., in a direction between the first and second side walls 110, 115). Each illustrated cavity 185 may include a substantially circular shape, although other examples may include one or more cavities with any other shape (e.g., elliptical, triangular, rectangular, etc.).

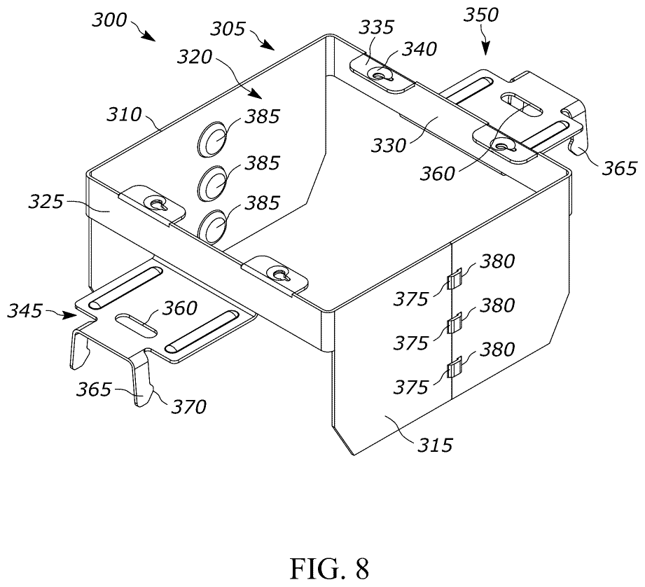

FIG. 8 shows an alternate example of a mounting plate 300. The mounting plate is substantially similar to the mounting plate 100 and similar features include the same reference numbers plus “200”. Only some similarities and differences are discussed below.

The mounting plate 300 includes a body 305. Like the mounting plate 100, the mounting plate 300 may be formed from a unitary, one-piece construction. Panels may be coupled together to form the second side wall 315 using one or more hooks 375 and slots 380 (e.g., three shown).

In some forms, the body 305 may be larger than the body 105. Specifically, the body 305 may include an opening 320 sized as a two-gang body 305 and may be able to receive larger or multiple electrical devices.

In certain forms, tabs 335 with mounting openings 340 may extend into the opening 320. The two-gang body 305 may include additional tabs 335 as compared to the single-gang body 105 to support larger devices and/or multiple devices.

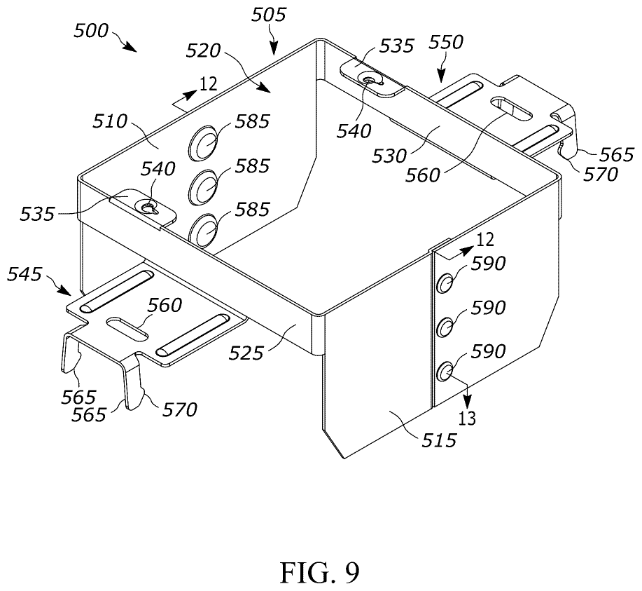

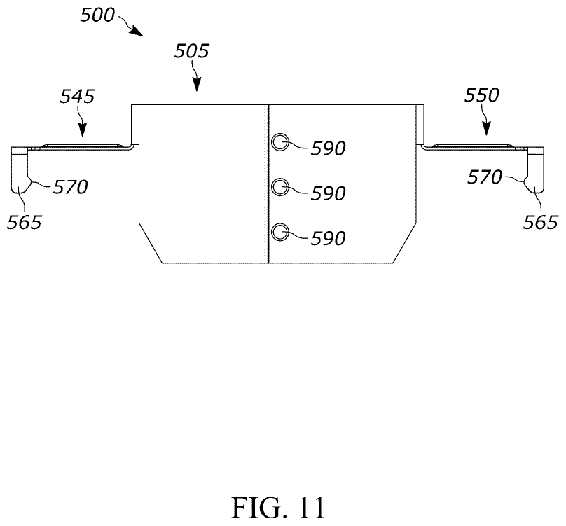

FIGS. 9 to 13 show an alternate example of a mounting plate 500. The mounting plate is substantially similar to the mounting plate 100 and similar features include the same reference numbers plus “400”. Only some similarities and differences are discussed below.

The mounting plate 500 includes a body 505. Like the mounting plate 300, the mounting plate 500 may be formed from a unitary, one-piece construction. Additionally, the body 505 and the opening 520 may be similarly sized to the body 305 and the opening 320 respectively and may be considered a two-gang body 505.

Like the mounting plates 100, 300, the mounting plate 500 may include panels that may be coupled together to form the second side wall 515. However, instead of using the above-described hooks and slots, the second side wall 515 may be formed via one or more clinch joints 590 (e.g., tog locks).

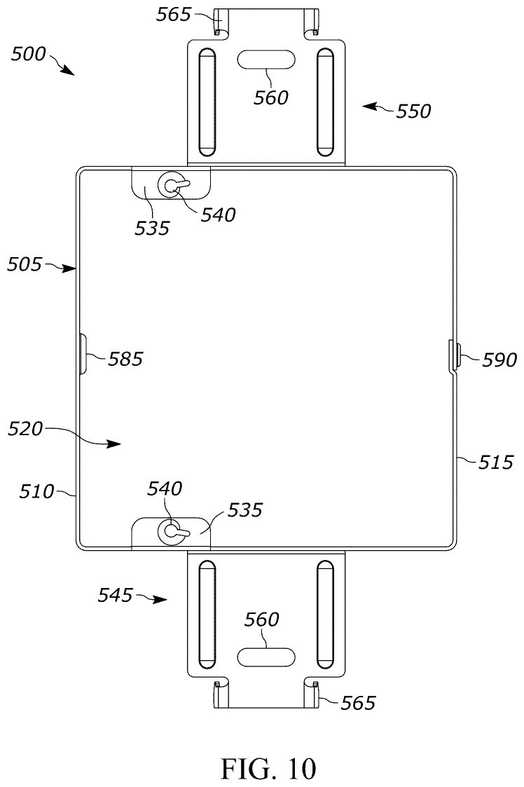

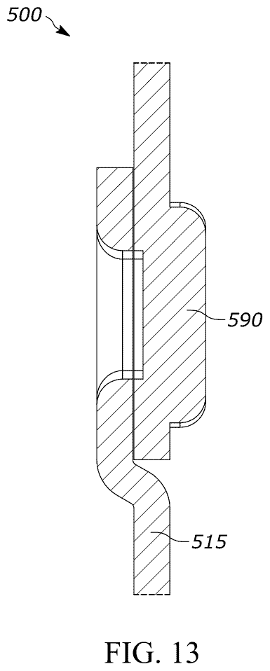

As shown in FIGS. 10 and 13, the two panels may be overlapped and at least one clinch may be used to interlock the two panels into the second side wall 515. The illustrated example includes three clinches in substantially the same location as the hooks and slots of the previously described mounting plates 100, 300.

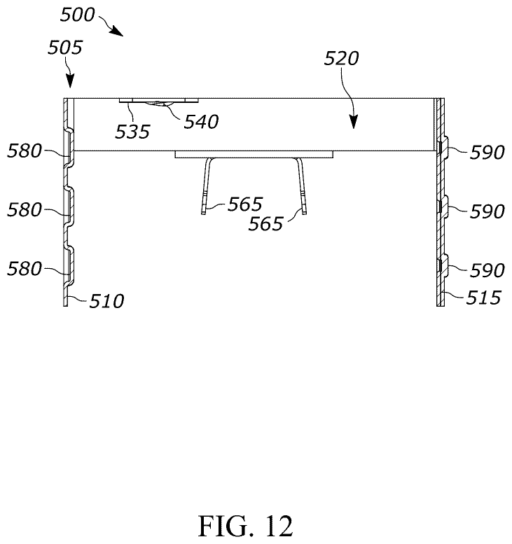

As shown in FIGS. 12 and 13, the joints 590 may protrude outwardly from the outer surface of the second side wall 515 (e.g., away from the volume at least partially formed by the first and second side walls 510, 515). The cavities 585 may be substantially aligned with the joints 590 and may be recessed in from the first side wall 510. The cavities 585 may be substantially the same size as the cavities 185, 385 and may be larger than the joints 590.

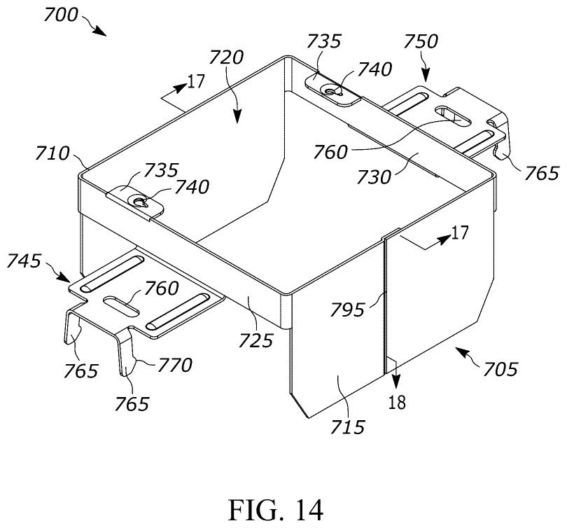

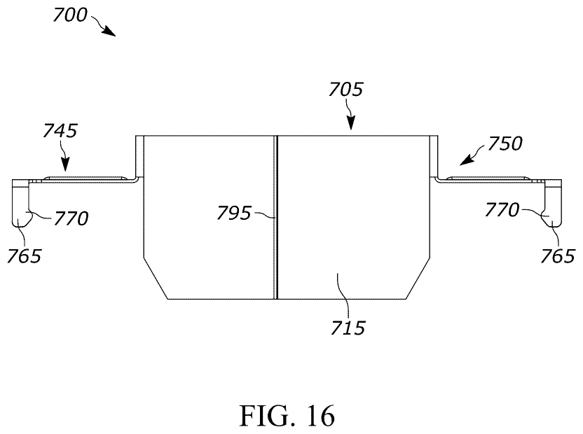

FIGS. 14 to 18 show an alternate example of a mounting plate 700. The mounting plate is substantially similar to the mounting plate 700 and similar features include the same reference numbers plus “600”. Only some similarities and differences are discussed below.

The mounting plate 700 includes a body 705. Like the mounting plates 300, 500, the mounting plate 700 may be formed from a unitary, one-piece construction. Additionally, the body 705 and the opening 720 may be similarly sized to the bodies 305, 505 and the openings 320, 520 respectively and may be considered a two-gang body 705.

Like the previously described mounting plates 100, 300, 500, the mounting plate 700 may include panels that may be coupled together to form the second side wall 715. However, instead of using the above-described hooks and slots, the second side wall 715 may be formed via a welded joint 795.

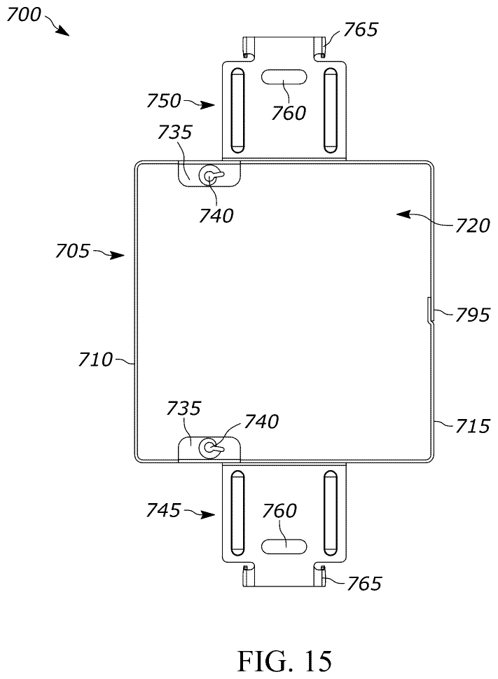

As shown in FIGS. 15 to 18, the two panels may be overlapped and may be welded together with a single weld joint 795 (although there could be multiple, discontinuous weld joints 795). The joint 795 may be in a substantially similar position as the hooks 175 and slots 180 and/or the clinches 590 (e.g., substantially in the middle of the second side wall 715).

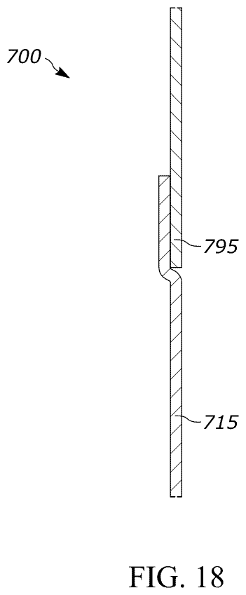

In certain forms, the second side wall 715 may be substantially planar. As shown in FIG. 18, one panel may be bent behind the other panel when they are welded to form the second side wall 715. The exposed portion of each panel when combined may be substantially flush.

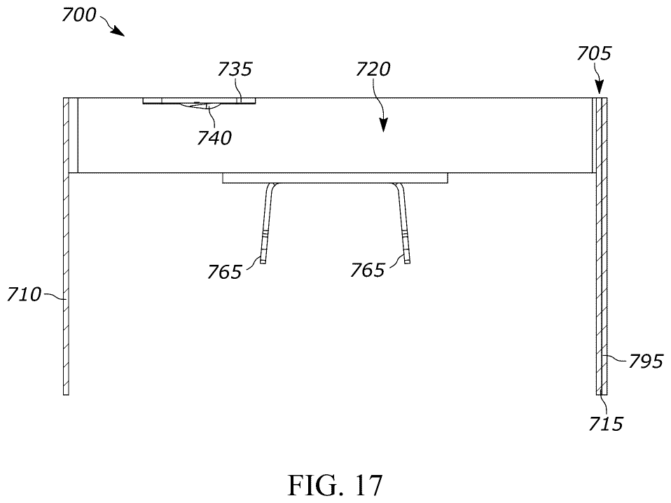

As shown in FIG. 17, the first side wall 710 may also be substantially planar. For example, the body 705 may not include the cavities. However, other examples of the first side wall 710 may still include the cavities.

Although the clinches and welds are only illustrated with a two-gang mounting plate, they may be incorporated into any variety of mounting plate (e.g., single gang, three gang, etc.). Additionally, the hooks and slots may be similarly incorporated into unillustrated varieties of mounting plates (e.g., three gang, etc.).

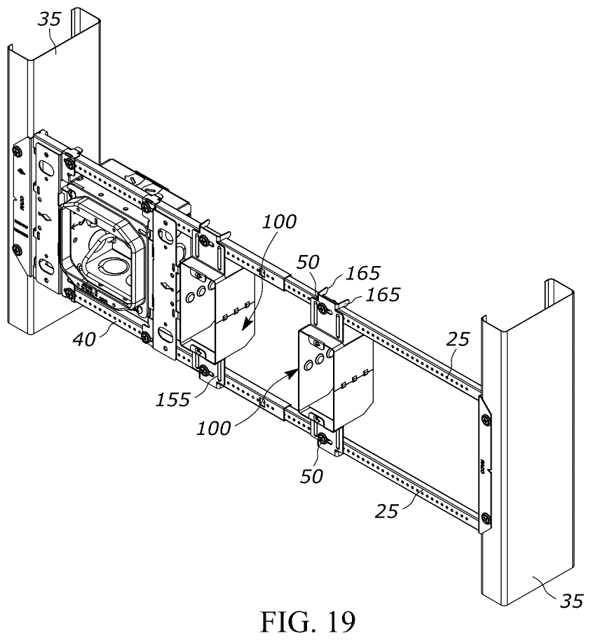

As shown in FIGS. 19 to 21, two or more mounting plates may be connected between rails 25 of a brace 30 to be supported in a ceiling or wall. The illustrated example shows two mounting plates 100. However, any number of mounting plates 100 may be used and/or any combination of mounting plates 100, 300, 500, 700, 900 may be used. For simplicity, the description will refer to the mounting plate 100.

The brace 30 may be mounted to a pair of supports 35 so that the rails 25 extend between the supports 35. The rails 25 may include a number of openings 40 that may be sized to receive fasteners (e.g., threaded screws).

Each mounting plate 100 may be positioned so that it extends across the rails 25. For example, the first mounting section 145 may be positioned proximate to one rail 25 and the second mounting section 150 may be positioned proximate to the other rail 25, and the body 105 may at least partially span the distance between the rails 25.

In some forms, the length of the mounting plate 100 may be greater than a maximum width between the rails 25. For example, ends of each of the mounting sections 145, 150 may extend at least partially beyond an outer edge of the respective rail 25. In particular, the connecting tabs 165 of each mounting section 145, 150 may extend beyond the other edge of the respective rail 25.

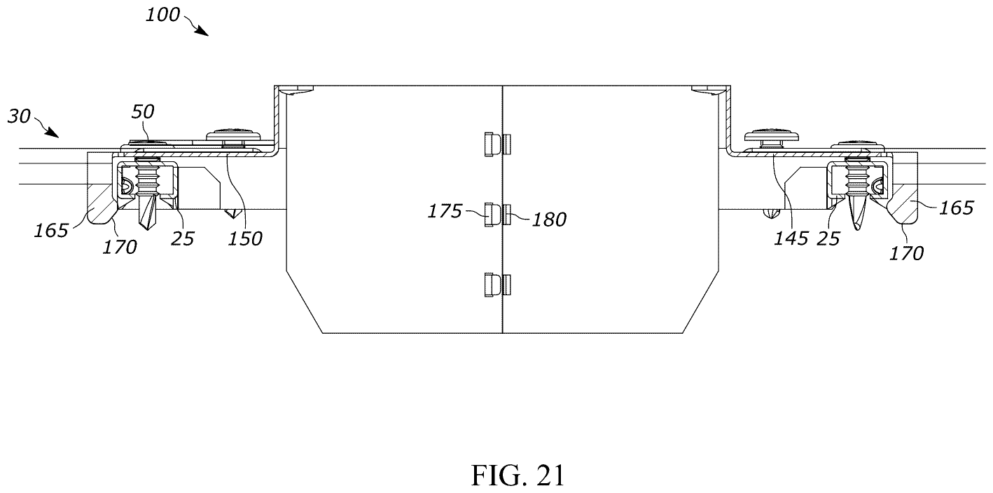

As shown in FIG. 21, certain forms of the connecting tabs 165 may engage the respective rail 25 to couple the mounting plate 100 to the brace 30. For example, the finger 170 of each may extend around a surface of the respective rail 25 to secure the mounting sections 145, 150 to the rail. This engagement may be a snap-fit engagement (although other types of engagements may be used). Because the mounting sections 145, 150 are integrally formed in a one-piece construction with the body 105, the snap-fit engagement of the mounting sections 145, 150 to the rails 25 couples the body to the rails 25.

In one form, the mounting plate 100 may be translatable along the rails 25 after the connecting tabs 165 engage the rails 25. For example, each of the mounting sections 145, 150 may be proximate to (or in contact with) the respective rail 25. The body 155 and fingers 170 of each mounting section 145, 150 may guide the mounting sections 145, 150 along the rail 25 to permit movement (e.g., sliding movement).

One or more mounting plates 100 may be connected in this manner and translated (e.g., slid) to a desired position. Once in the desired position, a fastener (e.g., a threaded fastener) 50 may be inserted through the aperture 160 in the body 155 and through one of the openings 40 in the rail 25. The fastener 50 may secure the mounting plate 100 in position and limit further translational movement.

In some forms, the elongated shape of the aperture 160 may be large enough to simultaneously align with multiple openings 40 on the rail 25. A user may choose which opening 40 in the rail 25 to insert the fastener 50 through. The larger aperture 160 may permit the mounting plate 100 to be used with a variety of different rails (e.g., with different-sized openings).

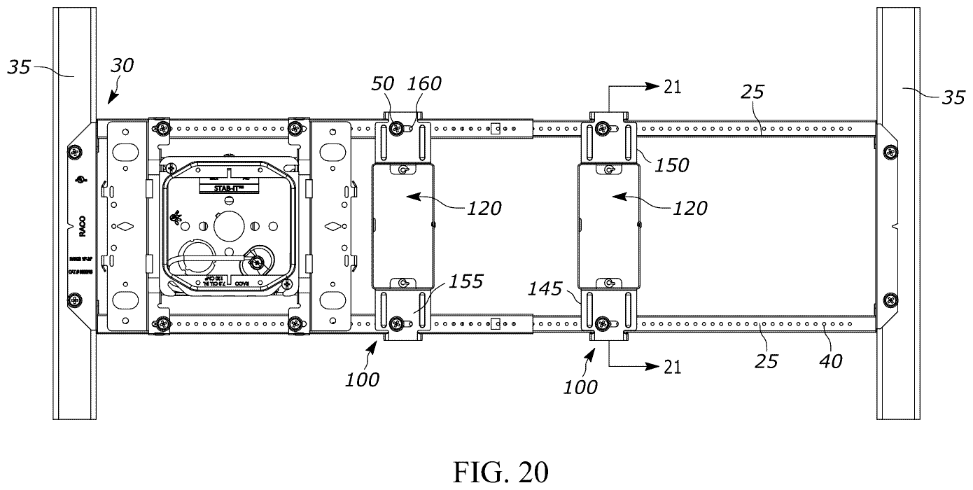

FIGS. 19 and 20 illustrate two mounting plates 100 positioned in a first configuration where the mounting plates 100 are spaced apart from one another. Because the mounting plates 100 are both single-gang brackets, this configuration may be used for two separate single-gang devices. However, as described above, at least one of the mounting plates 100 could be replaced with another sized mounting plate (e.g., two gang, three gang, etc.) and similarly spaced apart from any other bracket connected to the rails 25.

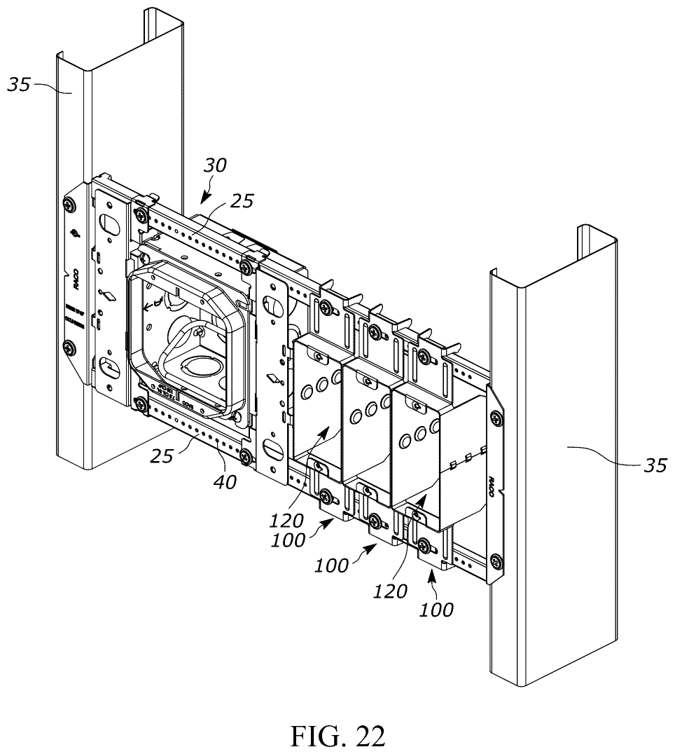

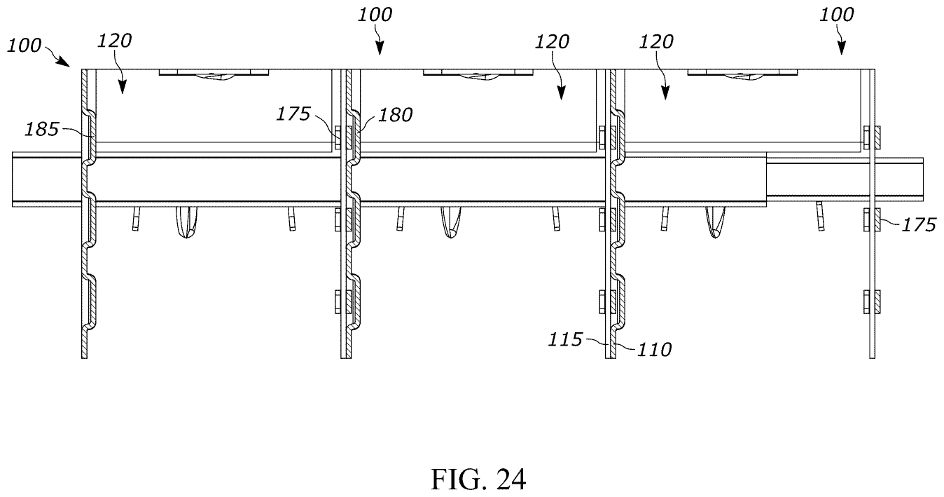

As shown in FIGS. 22 to 24, at least two mounting plates 100 (e.g., three shown) may be positioned in close proximity to one another. For example, the mounting plates 100 may be in contact with one another. Positioning the mounting plates 100 in this manner may permit a user to create different gang configurations using standard parts.

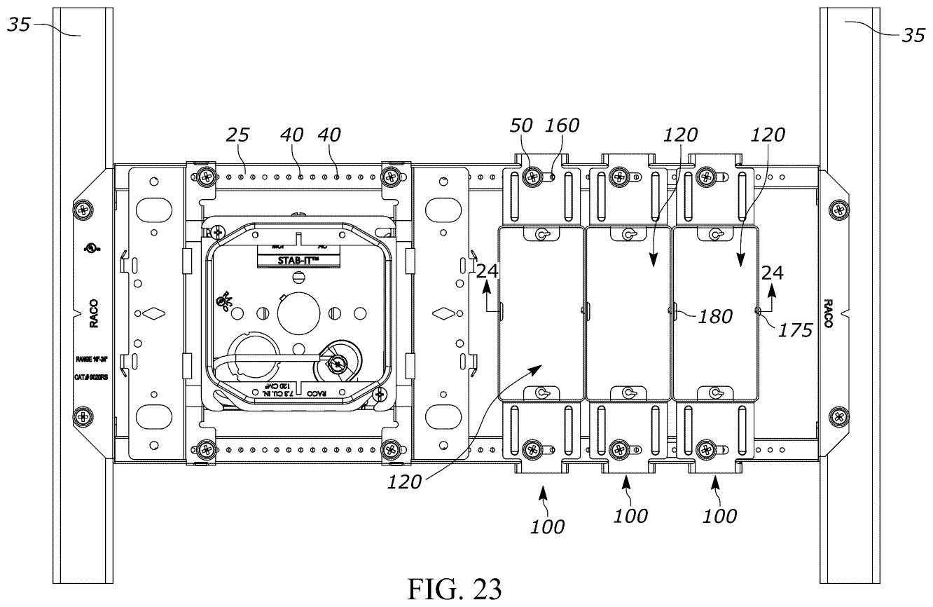

For example, FIGS. 22 and 23 illustrate three single-gang mounting plates 100 disposed in a second configuration where at least one side wall 110, 115 of one mounting plate 100 contacts a side wall 115, 110 of another mounting plate 100. Positioning mounting plates 100 next to one another orients the openings 120 of each mounting plate 100 proximate to one another, which may replicate a single, larger opening. In other words, positioning three single-gang mounting plates 100 next to one another may replicate a three-gang mounting plate.

Modular assembly of the mounting plates 100 requires fewer variations of elements but allows the user to achieve multiple final combinations. For example, combining any number of single-gang mounting plates 100 can create any sized final assembly. Additionally, a single-gang mounting plate 100 can be combined with a two-gang mounting plate (e.g., mounting plate 300) to similarly create a three-gang assembly.

As noted above, each mounting plate 100 is coupled to the rails 25 to be secured to the brace 30 (e.g., via the snap fit of the fingers 170 and/or by inserting a fastener 50 through the aperture 160). The mounting plates 100 are arranged so that they are in contact with one another. In this position, the hooks 175 of one mounting plate 100 may be in close proximity to the other mounting plate 100. More specifically, the first side surface 110 of the second mounting plate 100 may be limited from engaging flushly with the second side surface 115 of the first mounting plate 100 because the hooks 175 extend outwardly from the second side surface 115.

To permit the flush engagement between side surfaces 110, 115 on different mounting plates 100, the cavities 185 may be aligned with the hooks 175 in order to receive the hooks 175. Each cavity 185 may be sized to receive one of the hooks 175, thus permitting the side surfaces of adjacent mounting plates 100 to contact one another.

In some forms, the cavities 185 may be sufficiently large in order to accommodate any protrusion formed when connecting the panels to form the second side surface 115. For example, the joints 590 may be a similar size to the hooks 175 and may be similarly received within the cavity 185. Thus, mounting plates connected with different manufacturing methods may be used together.

In some forms, a second side surface formed via welding (e.g., weld joint 795) may be substantially flat and may not include a portion that projects outwardly. A cavity may not be needed to receive any portion of an adjacent mounting plate. Some mounting plates formed via welding (e.g., mounting plate 700) may therefore not include cavities on the first side surface 710. However, other examples may include the cavities in order to receive projections formed from other manufacturing methods so that the differently assembled mounting plates may be used together.

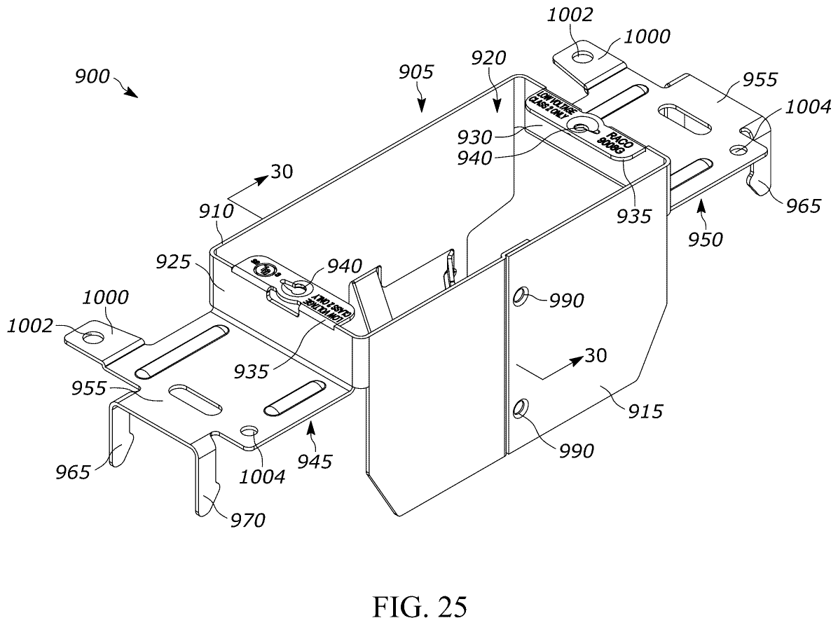

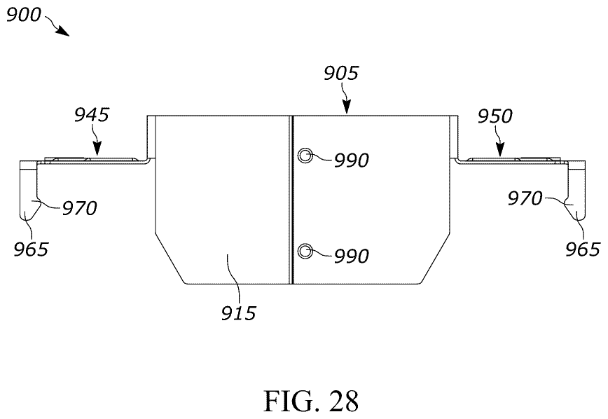

FIGS. 25 to 30 show an alternate example of a mounting plate 900. The mounting plate 900 is substantially similar to the mounting plate 500 and similar features include the same reference numbers plus “400”. Only some similarities and differences are discussed below.

The mounting plate 900 includes a body 905. Like the mounting plate 500, the mounting plate 900 may be formed from a unitary, one-piece construction. Additionally, the body 905 and the opening 920 may be similarly sized to the body 105 and the opening 120 respectively and may be considered a single-gang body 905. However, other examples of the body 905 may be a multi-gang body.

Like the mounting plate 500, the mounting plate 900 may include panels that may be coupled together to form the second side wall 915. Similar to the second side wall 515, the second side wall 915 may be formed via one or more clinch joints 990 (e.g., tog locks).

In certain forms, the clinch joints 990 may be inverted from the clinch joints 590. For example, the portion of the clinch joint 990 on the outer surface of the second side wall 915 may be formed as a cavity and protrude toward the opening 920. However, either of the clinch joints 590, 990 may be inverted from the orientation shown in the respective drawings.

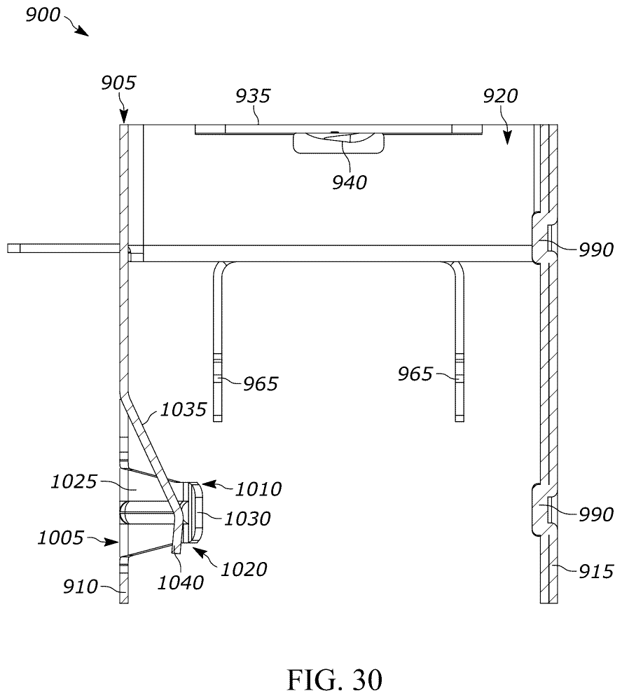

As shown in FIG. 30, the first side wall 910 may be substantially smooth in at least a region opposite to the clinch joints 990 (e.g., substantially the entire first side wall 910 is smooth). In other examples, the first side wall 910 may include cavities similar to the cavities 585.

Returning to FIGS. 25 to 27, the first and second mounting sections 945, 950 may each include a projection 1000. Each illustrated projection 1000 may extend outwardly from the respective mounting section 945, 950 in a direction parallel to the respective third and fourth side walls 925, 930. Each of the projections 1000 may include an aperture 1002 that can receive a fastener (described in more detail below).

As shown in FIG. 25, some forms of the projections 1000 may be disposed at least partially on a different plane than the respective mounting section 945, 950. For example, each projection 1000 may be positioned above the respective mounting section 945, 950 (e.g., in the opposite direction from the connecting tabs 965 on the same mounting section 945, 950).

In certain forms, the projections 1000 may be formed as a stepped surface from the respective mounting section 945, 950. The projections 1000 may be formed on a common plane (e.g., a plane extending through the third and fourth side walls 925, 930). Although in other examples, the projections 1000 may be formed on different planes.

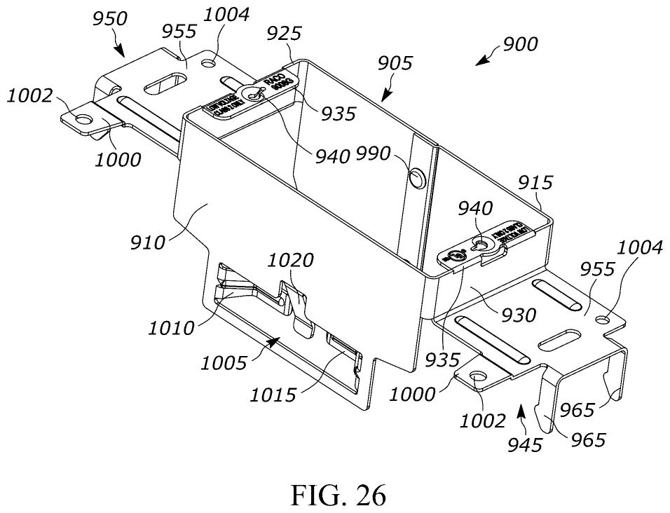

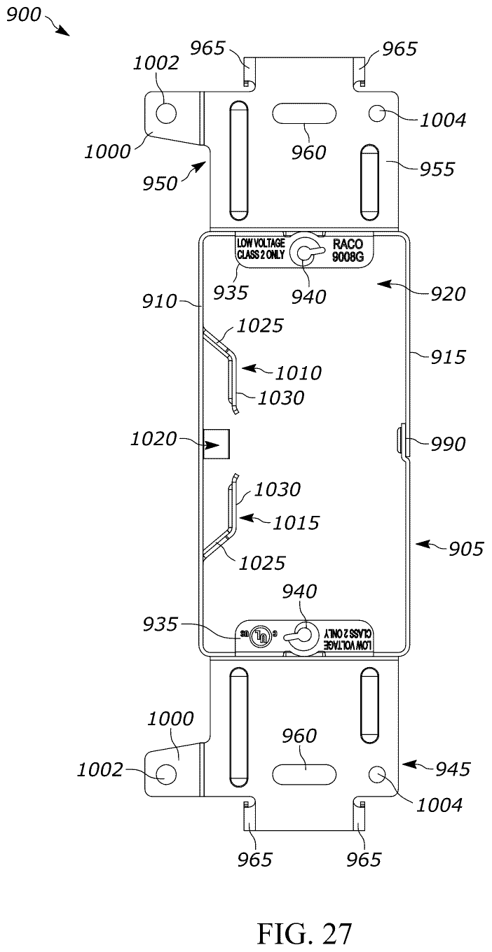

As shown in FIGS. 26 and 27, the first side wall 910 of the body 905 may include a cable opening 1005 that extends into the opening 920. The illustrated cable opening 1005 may be substantially rectangular, although other shapes may be used.

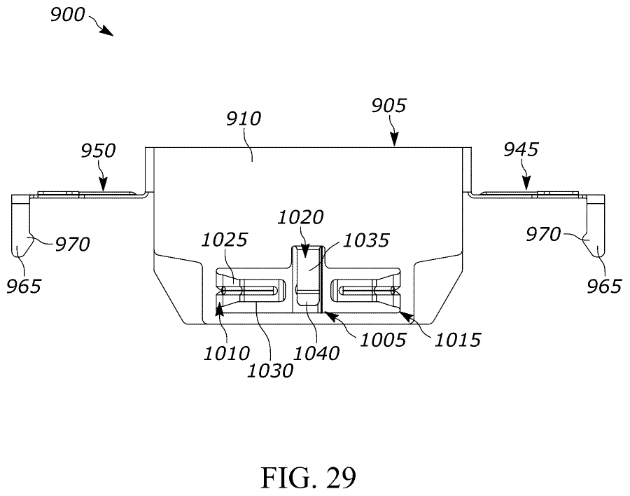

As shown in FIGS. 27 and 29, a first finger 1010, a second finger 1015, and a third finger 1020 may extend from the first side wall 910 and may at least partially cover the cable opening 1005. In the illustrated example, the first and second fingers 1010, 1015 may extend from opposite sides of the cable opening 1005 toward a center of the cable opening 1005 (e.g., the first and second fingers 1010, 1015 extend toward one another).

In some forms, the first and second fingers 1010, 1015 may extend along the opening 920 and away from the first side wall 910. Each of the fingers 1010, 1015 may be formed as a cantilever structure. For example, the first finger 1010 and the second finger 1015 may each include a first region 1025 and a second region 1030. As shown in FIG. 27, the first region 1025 of each finger 1010, 1015 may be inclined relative to the first side wall 910. Each second region 1030 may be inclined relative to the respective first region 1025, and the second regions 1030 may be parallel to one another (and to the first side wall 910).

As shown in FIGS. 29 and 30, the third finger 1020 may extend at least partially between the first and second fingers 1010, 1015. For example, the second regions 1030 of the first and second fingers 1010, 1015 may not overlap with the third finger 1020. Although in other example, the second regions 1030 may overlap at least a portion of the third finger 1020.

As shown in FIG. 30, the third finger 1020 may be formed as a cantilever structure. In some forms of the third finger 1020 may include a first region 1035 and a second region 1040. The first region 1035 may extend from the first side wall 910 and may be inclined relative to the first side wall 910. The second region 1040 may be inclined relative to the first region 1035 of the third finger 1020. The second region 1040 of the third finger 1020 may be inclined or parallel relative to the first side wall 910.

In some forms, the third finger 1020 may be disposed closer to the first side wall 910 than either of the first and second fingers 1010, 1015. For example, the second region 1040 of the third finger 1020 may be disposed closer to the first side wall 920 than the second region 1030 of either the first or second fingers 1010, 1015. However, in other examples, the second region 1040 of the third finger 1020 may be the same distance as the second region 1030 or further from the first side wall 920 than the second regions 1030.

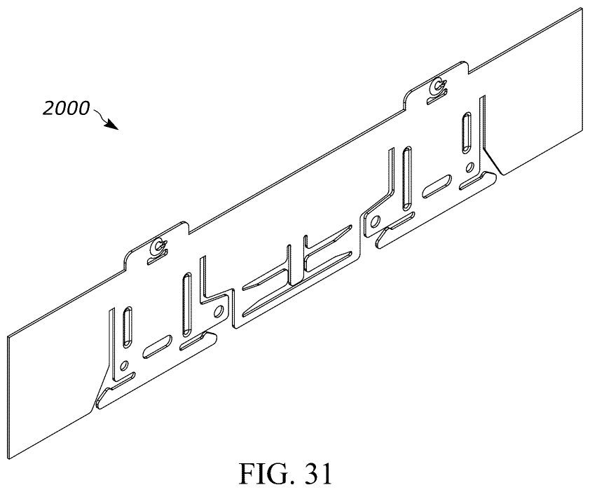

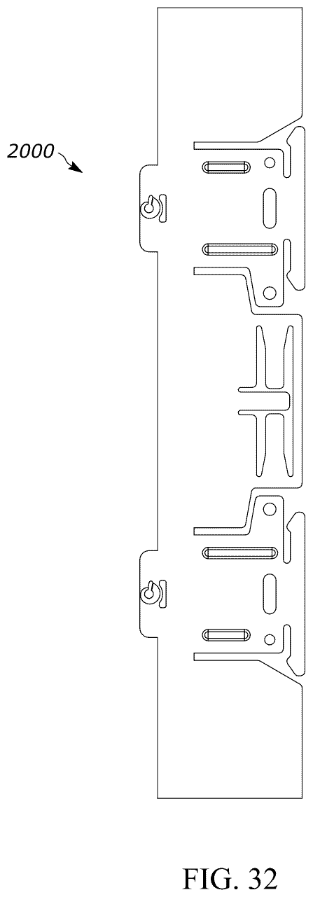

FIGS. 31 and 32 illustrate a blank 2000 that may be used to form the mounting plate 900. A similar blank 2000 may be used to form any of the other mounting plates described herein.

The illustrated blank 2000 may be substantially rectangular in shape and may be substantially flat, although other shapes and orientations may be used. The blank 2000 may be formed with the cutouts of the various elements. When forming the mounting plate 900, the blank 2000 may be bent into the shape of the body 905. The free ends of the brank 2000 may then be connected together using the clinch joint 990, or any of the other methods described above.

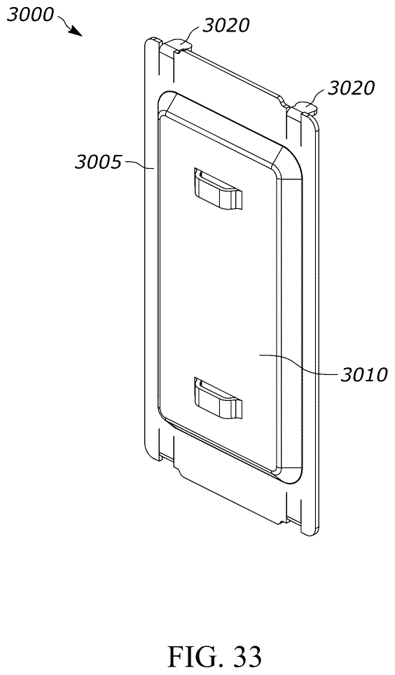

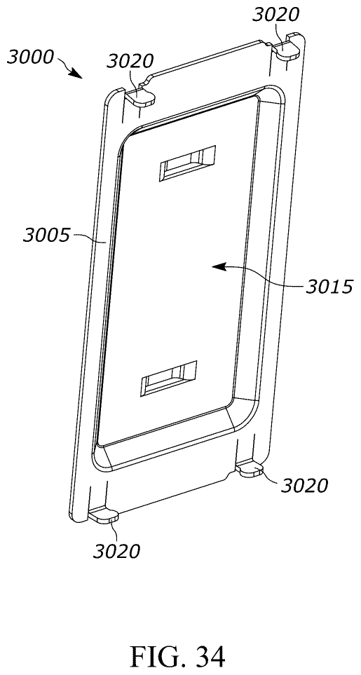

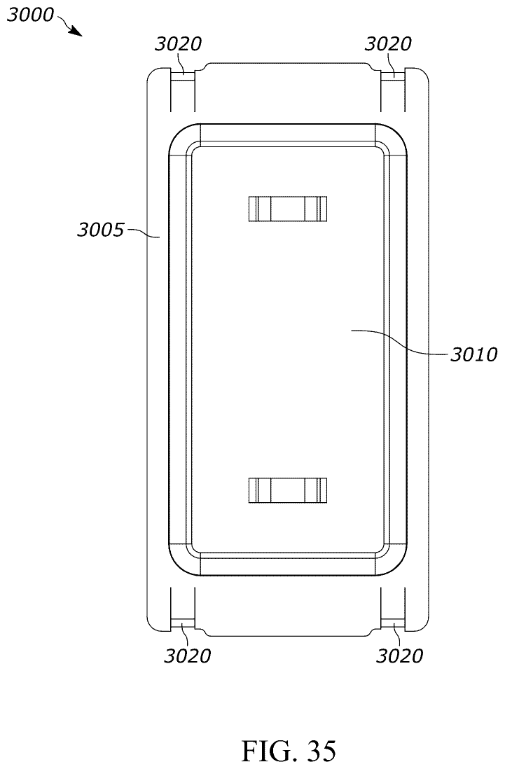

FIGS. 33 to 36 illustrate a protective cover 3000 that can be used during the installation process. The cover 3000 includes a front wall 3005 and a projected region 3010 that extends away from the front wall 3005. The projected region 3010 may at least partially form a cavity 3015 (see e.g., FIG. 34). The illustrated cavity 3015 may have a rectangular shape, although other examples of a cavity 3015 can have different shapes. The cavity 3015 may be sized and shaped to at least partially receive an electrical device (e.g., an electrical outlet). The cover 3000 may be similar to a cover described in U.S. Pat. No. 11,742,644, which is incorporated herein by reference in its entirety.

In some forms, the protective cover 3000 may include at least one tab 3020 (e.g., four shown). The tabs 3020 may extend from the front wall 3005 in a direction opposite to the projected region 3010. In the illustrated example, a tab 3020 may be disposed proximate each of the corners of the cover 3000, although the tabs 3020 may be disposed in other locations in other examples (e.g., proximate to a middle of each edge).

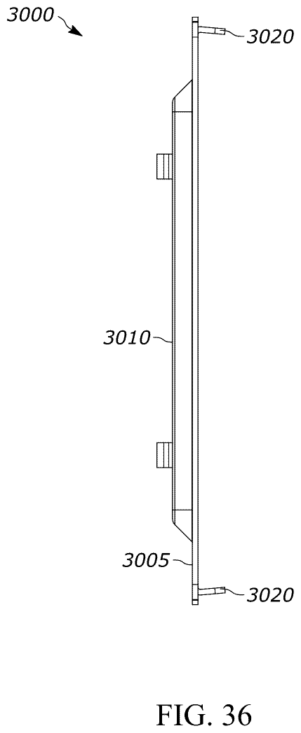

As shown in FIG. 36, each of the tabs 3020 may be formed as a cantilever member with a free end extending away from the front wall 3005. In the illustrated example, each of the tabs 3020 may be oriented with a substantially oblique angle relative to the front wall 3005. However, at least one of the tabs 3020 may be oriented substantially perpendicular with respect to the front wall 3005.

In certain forms, the tabs 3020 may be resilient members and may be bendable from a neutral position. For example, the tabs 3020 may have a neutral position as illustrated in FIG. 36, but may flex (e.g., toward the surface of the front wall 3005) when an external force is applied.

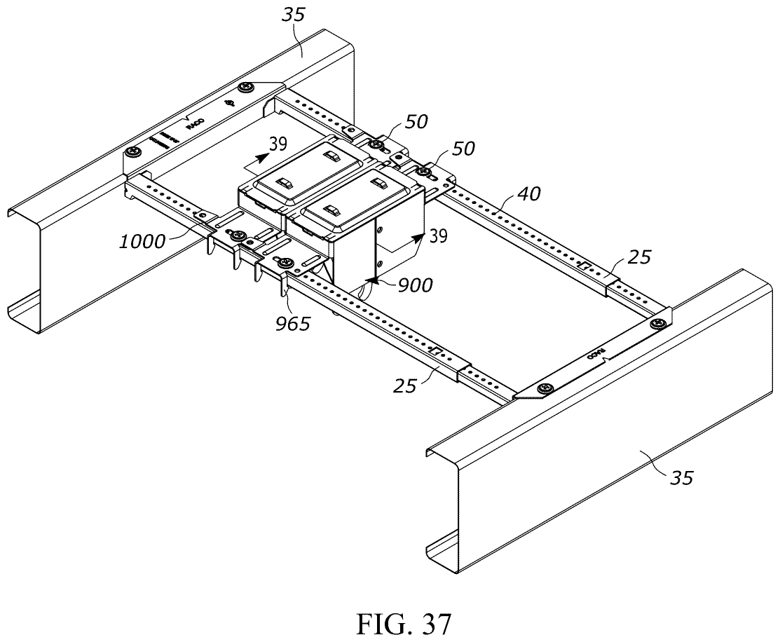

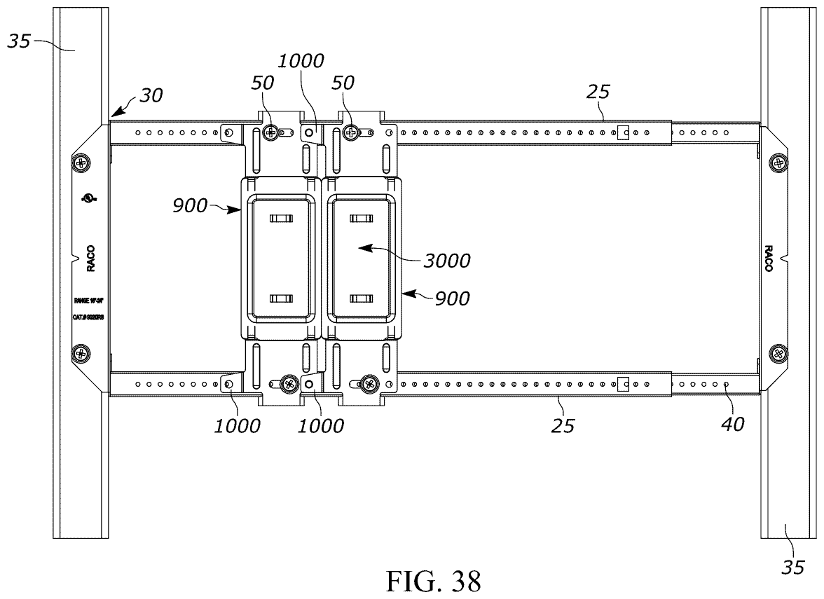

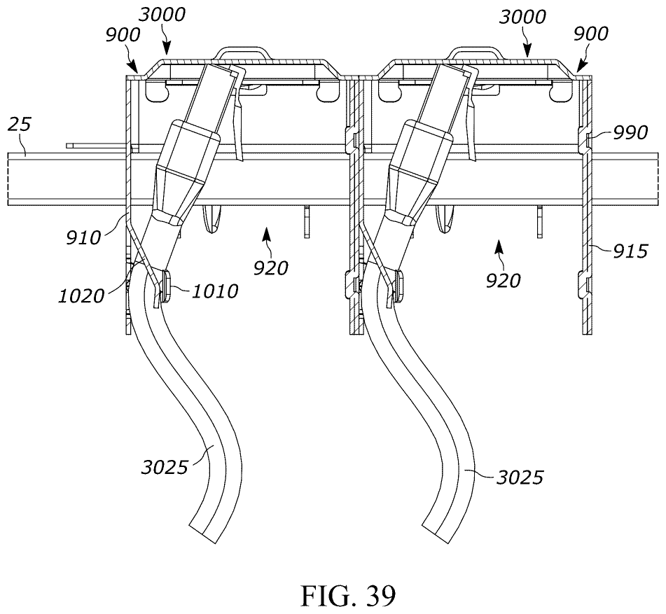

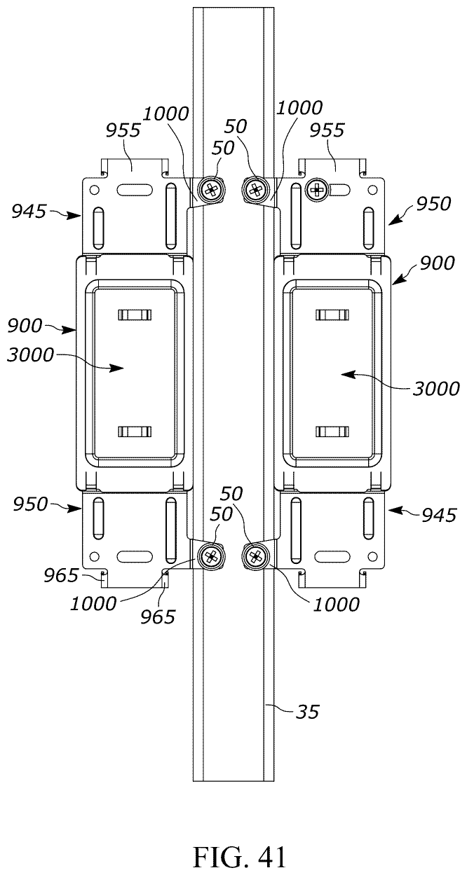

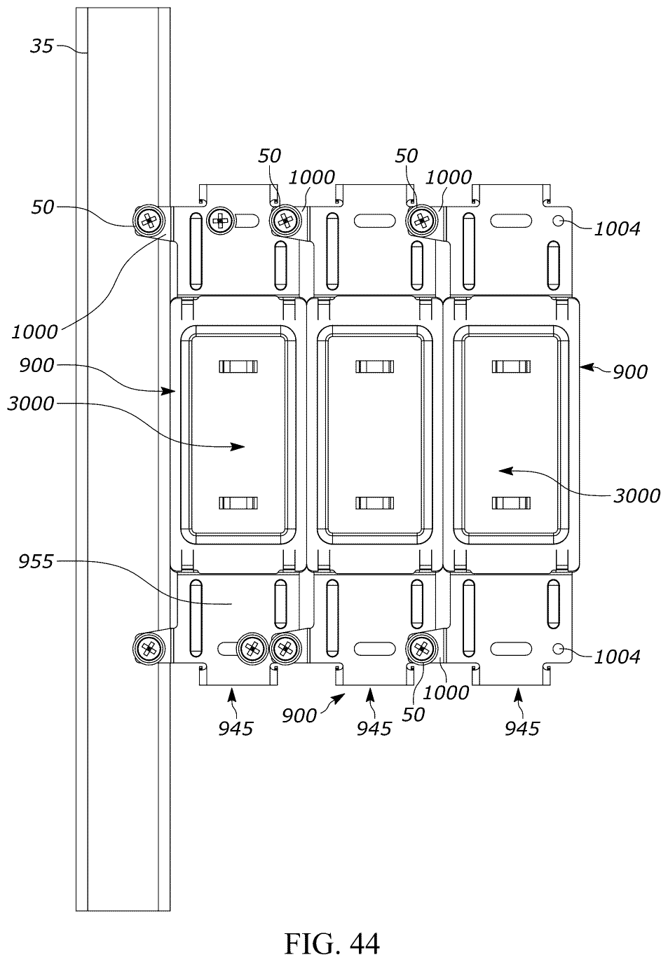

As shown in FIGS. 37 to 46, the cover 3000 may be connected to the mounting plate 900 (or any of the other described mounting plates). For example, the cover 3000 may be positioned over the opening 920 and may substantially cover the opening 920. The tabs 3020 may be received within the opening 920 and may assist in coupling the cover 3000 to the mounting plate 900. For example, the tabs 3000 may snap-fit into the opening 920 to couple the cover 3000 to the body 905. Alternatively, or in addition, the tabs 3000 may include magnets that removably couple to a surface of the body 905.

The cover 3000 can allow an electrical device to be installed prior to the installation of a surface material (e.g., sheet rock, wall board, or other material). For example, the electrical device and the mounting plate 900 can be installed by a technician (e.g., an electrician) with the cover 3000 in a single trip prior to installation of the wall panels or other surface material. After the surface material is installed, a technician (e.g., non-electrician) can cut openings around the mounting plate 900. Using the cover 3000 may save time because it reduces the amount of work that needs to be performed by an electrician and reduces the number of trips the electrician needs to make to a work site. Without the cover 3000, an electrician may need to return to the worksite after the cut is made in the surface material to wire the electrical device. After the cut is made, the cover 3000 may remain attached to the body 905 to minimize a wall covering (e.g., paint) contacting the mounting plate 900.

As shown in FIGS. 37 to 39, two or more mounting plates may be connected between rails 25 of a brace 30 to be supported in a ceiling or wall. The illustrated example shows two mounting plates 900. However, any number of mounting plates 900 may be used and/or any combination of mounting plates described herein may be used.

For example, FIGS. 37 to 39 illustrate two single-gang mounting plates 900 disposed adjacent to one another where the first side wall 110 of one mounting plate 900 contacts the second side wall 915 of another mounting plate 900. Positioning mounting plates 900 next to one another orients the openings 920 of each mounting plate 900 proximate to one another, which may replicate a single, larger opening. In other words, positioning two single-gang mounting plates 900 next to one another may replicate a two-gang mounting plate.

As noted above, each mounting plate 900 is coupled to the rails 25 to be secured to the brace 30 (e.g., via the snap fit of the fingers 970 and/or by inserting a fastener 50 through the aperture 960). The mounting plates 900 are arranged so that they are in contact with one another. In this position, the clinch joints 990 of one mounting plate 900 may be in close proximity to the other mounting plate 900. Because the clinch joints 990 are inverted and extend into the body 905, multiple mounting plates 900 may be able to sit flush with one another.

When adjacent to one another, the projections 1000 of one mounting plate 900 may overlap with the respective bodies 955 of the other mounting plate 900. The stepped surface of each projection 1000 permits limits interference between the body 955 of one mounting plate 900 and the projection 1000 of the other. In the illustrated example, a fastener may not be inserted through the aperture 1002 to connect the mounting plates 900 together. However, other examples may use a fastener to connect the mounting plates 900 in addition to the fasteners 50 connecting the bodies 955 to the rails 25.

In some forms, a cover 3000 may be connected to each of the bodies 905. When connected, an electrical device 3025 may be connected to one or more of the mounting plates 900 (e.g., both shown). The illustrated electrical device 3025 may be an electrical conductor, although any other electrical devices 3025 may be used.

In certain forms, the electrical cord 3025 may be connected to the mounting plate 900 via the cable opening 1005. For example, the electrical cord 3025 may be at least partially retained by one of the fingers 1010, 1015. The fingers 1010, 1015 may be resilient members that can flex to receive the electrical cord 3025 and then bias back toward the first side wall 910 to retain the electrical cord 3025.

The electrical cord 3025 may not substantially pass through the cable opening 1005. This may assist the mounting plate 900 in remaining substantially planar so that multiple mounting plates 900 can be positioned adjacent to one another.

In some forms, each of the first and second fingers 1010, 1015 may assist in retaining a separate electrical cord 3025 (e.g., may assist with cable management). The third finger 1020 may assist in separating the electrical cords 3025 retained by each of the first and second fingers 1010, 1015.

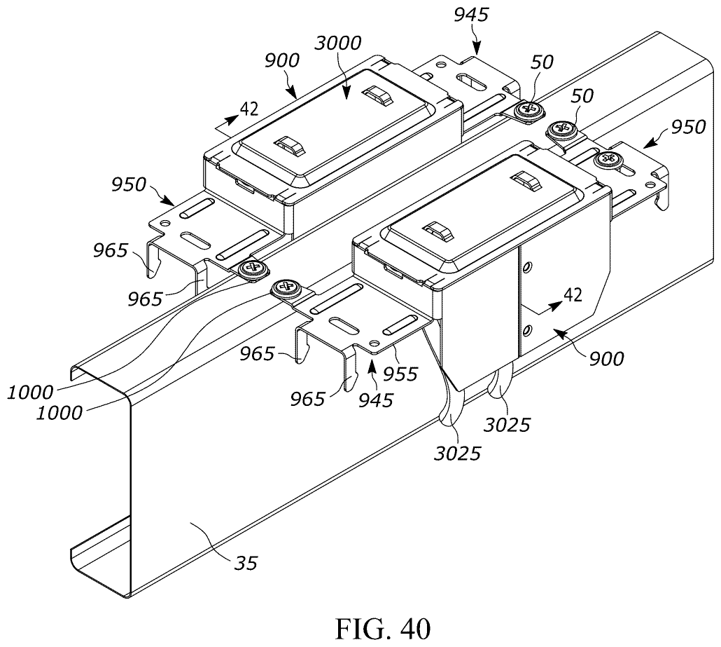

As shown in FIGS. 40 to 42, one or more mounting plates 900 (e.g., two shown) may be connected directly to a support 35 (e.g., to a front face or side face of the support 35). For example, this connection may eliminate the need for a brace 30 that indirectly couples a mounting plate 900 to the support 35.

In the illustrated example, two mounting plates 900 are connected to the support 35, with one mounting plate 900 connected on either side of the support 35. In other examples, a greater or lesser number of mounting plates 900 may be connected on either side of the support 35. The illustrated mounting plates 900 are also shown as being aligned across the support 35. In other examples,

The direct connection between the mounting plate 900 and the support 35 may be enabled by the projections 1000 that extend from first and second mounting sections 945, 950. As described above, the projections 1000 may extend in the same direction away from the respective body 955. The mounting plate 900 can be positioned so that both of the projections 1000 extend toward the support 35. The projections 1000 also may extend a sufficient distance from the respective body 955 so that the tabs 965 are spaced apart from the support 35. A fastener 50 may be inserted through the aperture 1002 in each projection 1000 to secure the respective mounting plate 900 in place.

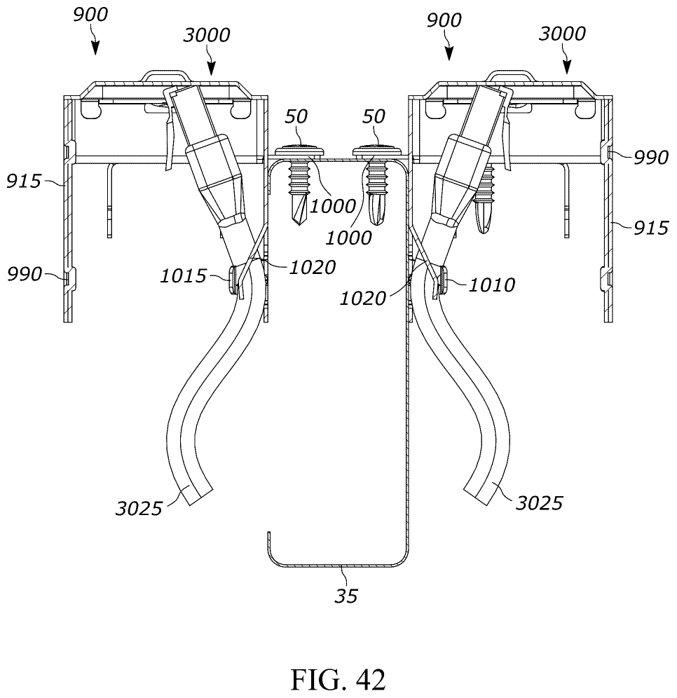

As shown in FIG. 42, the projections 1000 may extend from the same side of the body 905 as the cable opening 1005. When the mounting plate 900 is connected to the support 35, the cable opening 1005 may be positioned to face the support 35. This may provide additional assistance in retaining the electrical cord 3025 and/or to limit unintended removal of the electrical cord 3025.

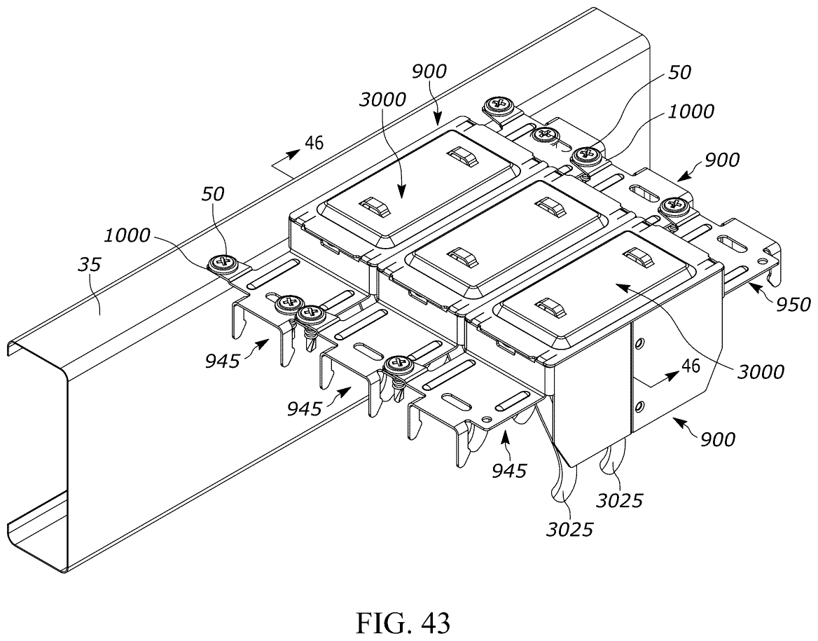

As shown in FIGS. 43 to 46, mounting plates 900 may be connected to the support 35 in an alternate configuration. For example, one mounting plate 900 may be connected directly to the support 35 as described above with respect to FIGS. 40 to 42. An additional mounting plate 900 may be connected to that mounting plate 900, and indirectly connected to the support 35.

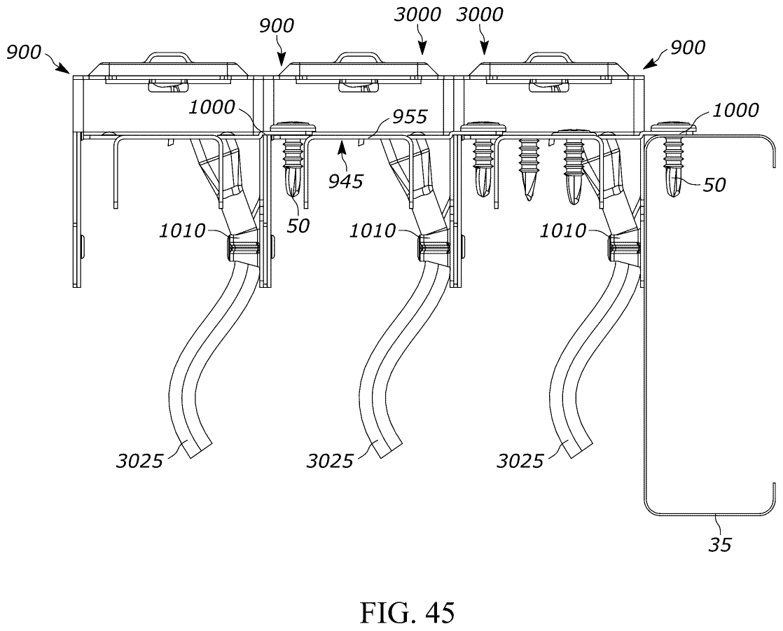

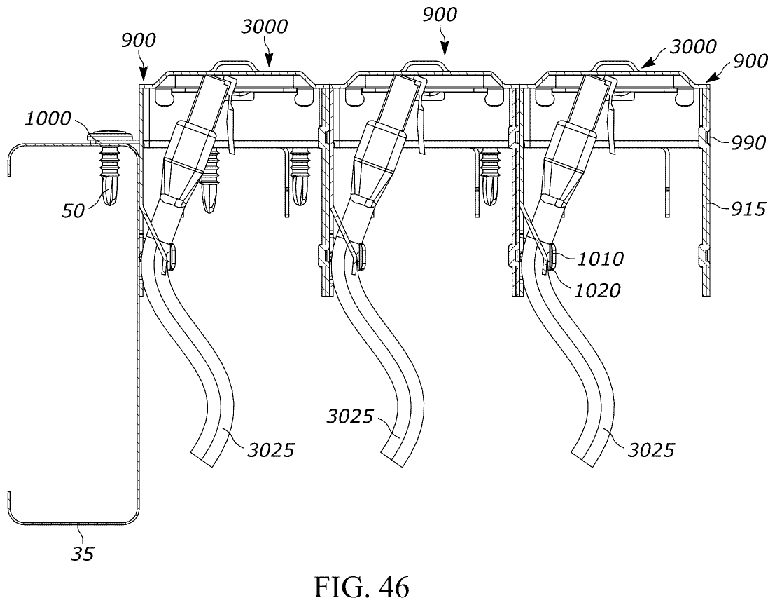

As described above, some forms of the projection 1000 may be a stepped portion relative to the respective body 955 of the respective mounting section 945, 950. This may limit interference and permit mounting plates 900 to be positioned adjacent to one another. For example, the stepped projection 1000 of one mounting section 945 may rest on the body 955 of the mounting section 945 of an adjacent mounting plate 900. As shown in FIGS. 45 and 46, this may permit the bodies 905 of each mounting plate 900 to be positioned at substantially the same height when connected.

To connect multiple mounting plates 900 together, the projections 1000 of one mounting plate 900 may be positioned over the respective mounting sections 945, 950 of an adjacent mounting plate 900. In this position, the apertures 1002 of the projections 1000 may be aligned with apertures 1004 on the respective mounting sections 945, 950. A fastener 50 may be inserted through each pair of aligned apertures 1002, 1004 to connect the adjacent mounting plates 900.

As described above (see e.g., FIGS. 22 to 24), multiple mounting plates may be connected adjacent to one another to replicate a multi-gang mounting plate using smaller mounting plates. For example, FIGS. 43 to 46 illustrate three single-gang mounting plates 900 connected adjacent to one another, which can be used to replicate a three-gang mounting plate. Other examples may include a greater or fewer number of adjacent mounting plates 900 to modularly construct a resulting mounting plate of a different size.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A mounting plate for a low voltage device, the mounting plate comprising:
a body including,
a first side wall having a recessed region, and
a second side wall opposite to the first side wall, the second side wall including a projection aligned with the recessed region,
wherein the first side wall and the second side wall extend between a first end and a second end of the body;
an opening formed between the first side wall and the second side wall;
a first mounting section coupled between the first side wall and the second side wall on the first end of the body; and
a second mounting section coupled between the first side wall and the second side wall on the second end of the body.

2. The mounting plate of claim 1, wherein the opening is a single gang opening.

3. The mounting plate of claim 1, wherein the opening is a two gang opening.

4. The mounting plate of claim 1, wherein the projection is formed by a clinch joint that couples a first panel of the second side wall to a second panel of the second side wall.

5. The mounting plate of claim 1, wherein the second side wall includes a first panel having an aperture and a second panel having a hook, and wherein the projection is formed by the hook being inserted into the aperture to couple the first panel to the second panel.

6. The mounting plate of claim 1, wherein the first mounting section includes a tab with a finger, wherein the finger is configured to snap fit to a rail to mount the mounting plate.

7. The mounting plate of claim 1, wherein the body further includes a tab having a fastener opening that is configured to receive a fastener to connect the body to an electrical device.

8. A method of manufacturing a mounting plate comprising:
forming a blank from a piece of material;
bending the blank into a mounting panel having a three-dimensional shape, the mounting panel including,
a first side wall with a first end and a second end,
a first mounting section coupled to the first end,
a second mounting section coupled to the second end,
a first panel connected to the first mounting section and positioned opposite of the first side wall, and
a second panel connected to the second mounting section and positioned opposite of the first side wall; and
coupling the first panel to the second panel to form a second side wall opposite the first side wall;
wherein an opening is at least partially formed between the first side wall and the second side wall.

9. The method of claim 8, wherein coupling further includes bending a hook from the first panel into an opening in the second panel.

10. The method of claim 8, wherein coupling further includes clinching the first panel to the second panel.

11. The method of claim 8, wherein coupling further includes welding the first panel to the second panel.

12. The method of claim 8, wherein the first mounting section includes a body with a pair of tabs, each tab includes a finger that is configured to snap-fit onto a rail to support an assembled mounting plate.

13. The method of claim 8, wherein the first mounting section includes a body and a tab, the method further comprising bending the tab from a first position substantially coplanar to the body to a second position oblique with respect to the body.

14. The method of claim 13, wherein the first mounting section further includes a projection, the method further comprising bending the projection from a third position substantially coplanar to the body and the tab in the first position to a fourth position substantially parallel to the body, wherein the projection includes a first mounting aperture and the body includes a second mounting aperture aligned along a first axis perpendicular to a second axis that extends between the first end and the second end, and wherein the first side wall includes a cable opening and a finger extending at least partially along the cable opening, the method further comprising being the finger at least partially out of the cable opening.

15. (canceled)

16. (canceled)

17. A method of mounting a low voltage device, the method comprising:
selecting a first mounting plate having a first opening with a first gang size and a second mounting plate having a second opening with a second gang size;
connecting the first mounting plate and the second mounting plate between a pair of rails;
securing the first mounting plate to the rails;
securing the second mounting plate to the rails in contact with the first mounting plate; and
combining the first opening and the second opening to form a third gang size that is equal to the first gang size plus the second gang size.

18. The method of claim 17, wherein securing the first mounting plate and the second mounting plate to the rails is done with a snap fit.

19. The method of claim 17, wherein the first mounting plate includes a projection, and the second mounting plate includes a cavity configured to receive the projection to permit the second mounting plate to contact the first mounting plate.

20. The method of claim 19, wherein the projection is formed from a clinch joint for maintaining a three-dimensional position of the first mounting plate.

21. The method of claim 19, wherein the projection is formed from a hook extending from a wall of the first mounting plate and received within an opening in the wall, the hook maintains a three-dimensional position of the first mounting plate.

22. (canceled)

23. (canceled)

24. The method of claim 17, further comprising,
positioning a first electrical device within the first opening;
connecting a protective cover to the first mounting plate with a snap fit to cover the first opening;
installing a surface material over the first mounting plate and the rails;
cutting the surface material to expose the protective cover; and
removing the protective cover.

25.-41. (canceled)
